(19) United States
(12) Patent Application Publication
(10) Pub. No.: US 2007/0282976 A1
(43) Pub. Date: Dec. 6, 2007

(54) System, method and program for controlling image display

(75) Inventor: Tadashi Matsuda, Ome-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/806,204

(22) Filed: May 30, 2007

(30) Foreign Application Priority Data
May 30, 2006 (JP) 2006-150029

(51) Int. Cl. G06F 15/16; G06F 12/00

(52) U.S. Cl. 709/217; 709/219

(57) ABSTRACT

According to one embodiment, an image display control system includes a transmitting-side information processing device comprising shared data and a receiving-side information processing device viewing the shared data via a network. The transmitting-side information processing device further comprises transmission means for, upon receiving an access from the receiving-side information processing device, transmitting list information of the shared data and local time information in a location where the transmitting-side information processing device is provided, to the receiving-side information processing device making the access. The receiving-side information processing device includes storage means for storing time-corresponding data, and display means for associating the time-corresponding data which are read with the received list information of the shared data, and displaying the shared data together with the time-corresponding data.

### CROSS-REFERENCE TO RELATED APPLICATIONS

This application is based upon and claims the benefit of priority from Japanese Patent Application No. 2006-150029, filed May 30, 2006, the entire contents of which are incorporated herein by reference.

### BACKGROUND

1. Field

One embodiment of the invention relates to the present invention relates to a display technique of shared data of a computer connected in a network and, more particularly, to a system, an image and a system for image display control, capable of visually displaying the data in association with the time in a location where the computer is provided.

2. Description of the Related Art

In general, when shared data are displayed on a computer connected to a network, a local time in a location where a computer storing the shared data is provided is not displayed. For example, JP-A No. 11-184603 (KOKAI) discloses a technique of displaying images in association with a local time in a location where a computer of a viewer viewing the shared data is provided.

According to the technique, however, it is impossible to display both the images in association with the local time in the location where the computer of a viewer viewing the shared data is provided, and the local time in the location where the computer storing the shared data is provided. Thus, if there is a time difference between the computer storing the shared data and the computer to view the shared data, the local time of the computer storing the shared data cannot be recognized by the computer to view the shared data.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary illustration of an image display control system according to an embodiment of the present invention;

FIG. 2 is an exemplary block diagram showing main portions of the image display control system according to the embodiment of the present invention;

FIG. 3 is an exemplary flowchart of a method and a program for image display control to which the image display control system according to the embodiment of the present invention is applied;

FIG. 4 is an exemplary illustration showing “table of correspondence between background images and time” according to the embodiment;

FIG. 5 is an exemplary illustration showing a display figure of a shared file list used in a time zone in the morning according to the embodiment;

FIG. 6 is an exemplary illustration showing a display figure of a shared file list used in a time zone in the daytime according to the embodiment;

FIG. 7 is an exemplary illustration showing a display figure of a shared file list used in a time zone in the evening according to the embodiment;

FIG. 8 is an exemplary illustration showing a display figure of a shared file list used in a time zone in the night according to the embodiment;

FIG. 9 is an exemplary illustration showing login information of each user to a computer storing shared data according to the embodiment;

FIG. 10 is an exemplary illustration showing a data list in a case where the present invention is applied to the data list such as a database according to the embodiment;

FIG. 11 is an exemplary illustration showing a use mode of changing a shape of a displayed window frame according to the time zone; and

FIG. 12 is an exemplary illustration showing a use mode of changing a shape of a displayed icon according to the time zone.

### DETAILED DESCRIPTION

Various embodiments according to the invention will be described hereinafter with reference to the accompanying drawings. In general, according to one embodiment of the invention, an image display control system includes a transmitting-side information processing device comprising shared data and a receiving-side information processing device viewing the shared data via a network.

The transmitting-side information processing device further comprises transmission means for, upon receiving an access from the receiving-side information processing device, transmitting list information of the shared data and local time information in a location where the transmitting-side information processing device is provided, to the receiving-side information processing device making the access.

The receiving-side information processing device comprises: storage means for storing time-corresponding data; reading means for receiving the list information of the shared data and the local time information in a location where the transmitting-side information processing device is provided, transmitted from the transmission means, and reading the time-corresponding data that correspond to the received local time information from the storage means; and display means for associating the time-corresponding data which are read by the reading means with the received list information of the shared data, and displaying the shared data together with the time-corresponding data.

Embodiments of the present invention will be described with reference to the accompanying drawings.

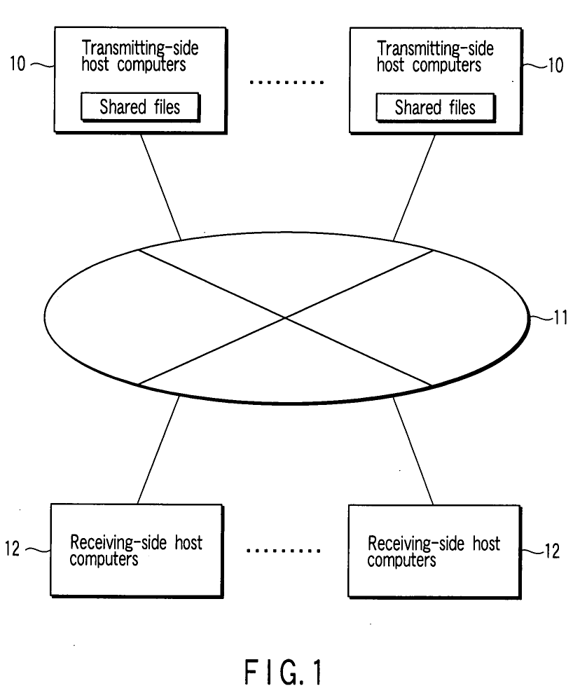

FIG. 1 is an illustration of an image display control system according to an embodiment of the present invention.

The image display control system is a technique by which, for example, if there is a time difference between a computer storing shared data and a computer to view the shared data, a local time of the computer storing the shared data can be recognized by the computer to view the shared data. The shared data are explained below as files which are set to be shared on the computer storing the shared data.

The image display control system is composed of a plurality of transmitting-side host computers 10 storing the shared files, a network 11 such as Internet which is connectable to the transmitting-side host computers 10, and a plurality of receiving-side host computers 12 viewing shared files connectable to the network 11.

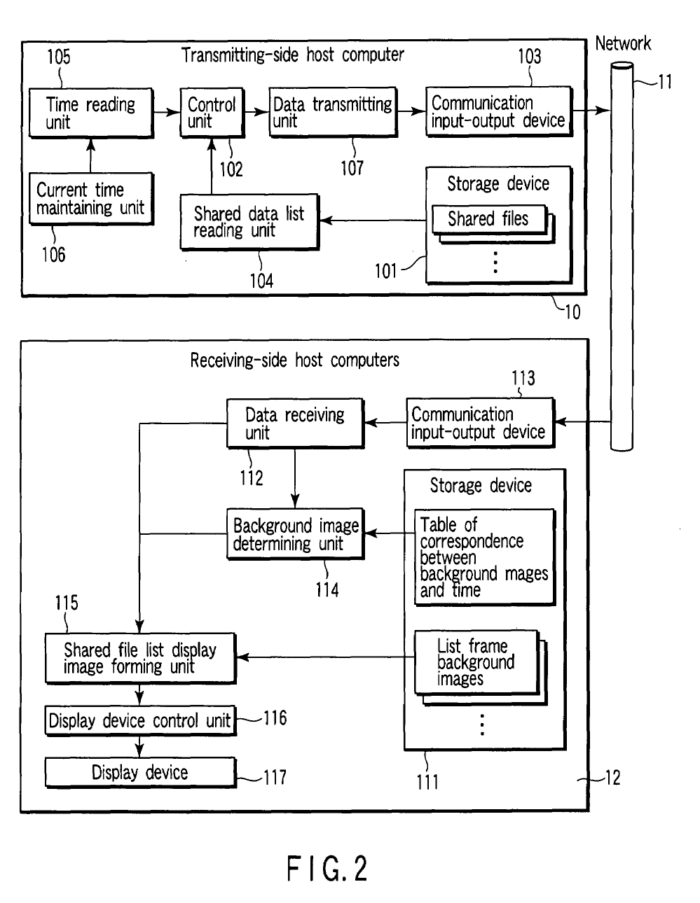

FIG. 2 is a block diagram showing main portions of the image display control system according to the embodiment of the present invention.

Each of the transmitting-side host computers 10 comprises a current time maintaining unit 106 storing a current time (local time) in a location where the transmitting-side host computer 10 is provided, a time reading unit 105 reading time information from the current time maintaining unit 106, a storage device 101 such as a hard disk drive (HDD) storing the shared files which are set to be shared, a shared data list reading unit 104 reading a list of shared data such as the shared files from the storage device 101, a control unit 102 associating the current time information called up from the time reading unit 105 with the shared data list information called up from the shared data list reading unit 104 in response to the request from the receiving-side host computer 12, a data transmitting unit 107 transmitting the associated current time information and shared data list information to the receiving-side host computer 12 via a communication input-output device 103, and the communication input-output device 103.

Each of the receiving-side host computers 12 comprises a communication input-output device 113, a data receiving unit 112 receiving current time information and shared data list information via the network 11 and the communication input-output device 113, a storage device 111 such as a hard disk drive (HDD) storing table information of correspondence between image data (background images) which are time-corresponding data and the time, and background images (list frame background images) to be displayed inside a display frame of the file list, a background image determining unit 114 reading from the storage device 111 background images corresponding to the current time information and the shared data list information received by the data receiving unit 112 by referring to the list frame background images, a shared file list display image forming unit 115 forming a display screen by associating the background image read by the background image determining unit 114 with the shared data list information received by the data receiving unit 112, a display device control unit 116 performing control to display the display screen formed by the shared file list display image forming unit 115 on a display device 117, and the display device 117 displaying the formed display screen.

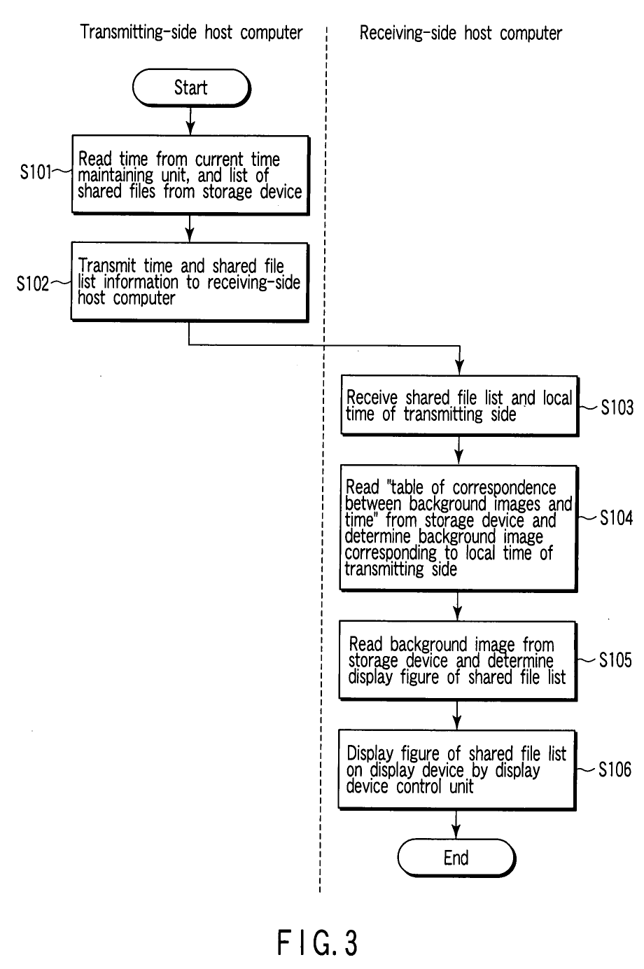

Next, a method and a program for image display control to which the image display control system according to the embodiment of the present invention is applied, are described with reference to the flowchart of FIG. 3.

First, the storage device 111 of the receiving-side host computer 12 preliminary stores the “background images” and the “table of correspondence between background images and time” that are the time-corresponding data.

The time reading unit 105 of the transmitting-side host computer 10 reads the time information from the current time maintaining unit 106 and sends the time information to the control unit 102, in response to a request of viewing the shared files from the receiving-side host computer 12. Moreover, the shared data list reading unit 104 reads the list information of the shared data from the storage device 101 and sends the list information to the control unit 102 (step S101).

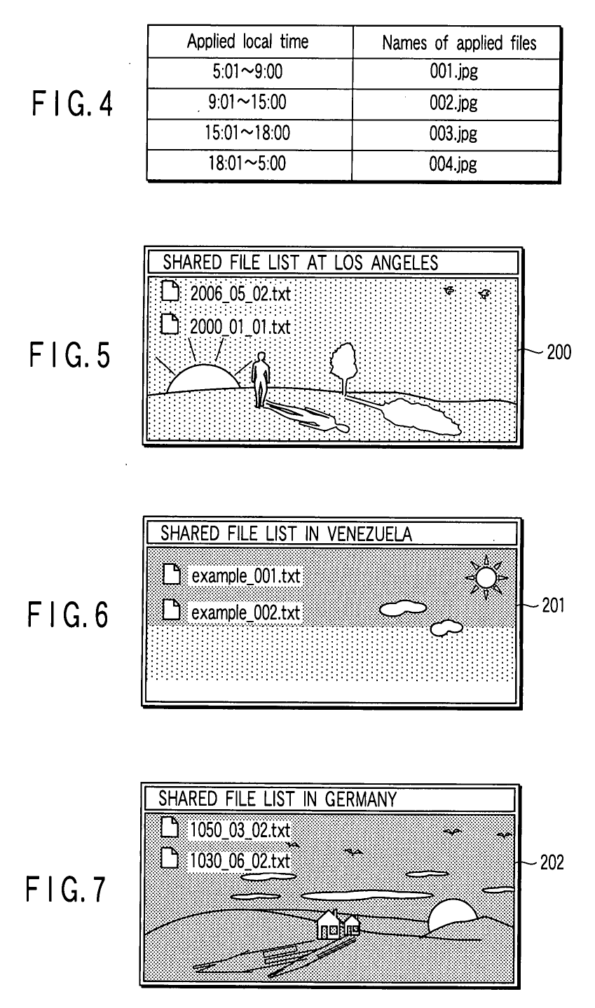

The control unit 102 associates the received time information and shared data list information and sends them to the data transmitting unit 107. The data transmitting unit 107 transmits the associated time information and shared data list information to the receiving-side host computer 12 via the communication input-output device 103 and the network 11 (step S102). The receiving-side host computer 12 receives the associated time information and shared data list information via the communication input-output device 113 (step S103). The background image determining unit 114 of the receiving-side host computer 12 reads the “table of correspondence between background images and time” from the storage device 111 and determines the background image corresponding to the received time information (step S104). A process of determining the background image corresponding to the time information is executed by the “table of correspondence between background images and time” shown in FIG. 4. For example, if the time information received from the transmitting-side host computer 10 is 6 o'clock in the morning, an applied file “001.jpg” is determined as the background image since 6 o'clock in the morning is applied to a period from 5:01 to 9:00 of the “table of correspondence between background images and time”. The applied file “001.jpg” is the background image in which an image of sunrise is drawn and from which the time can be understood intuitively as shown in, for example, FIG. 5.

The shared file list display image forming unit 115 reads the background image determined by the background image determining unit 114, from the storage device 111, and determines and forms a display figure (display screen) of the shared file list as shown in FIG. 5 in association with the shared data list information received from the transmitting-side host computer 10 (step S105). Subsequently, the display device control unit 116 outputs the formed display figure of the shared file list to the display device 117 (step S106).

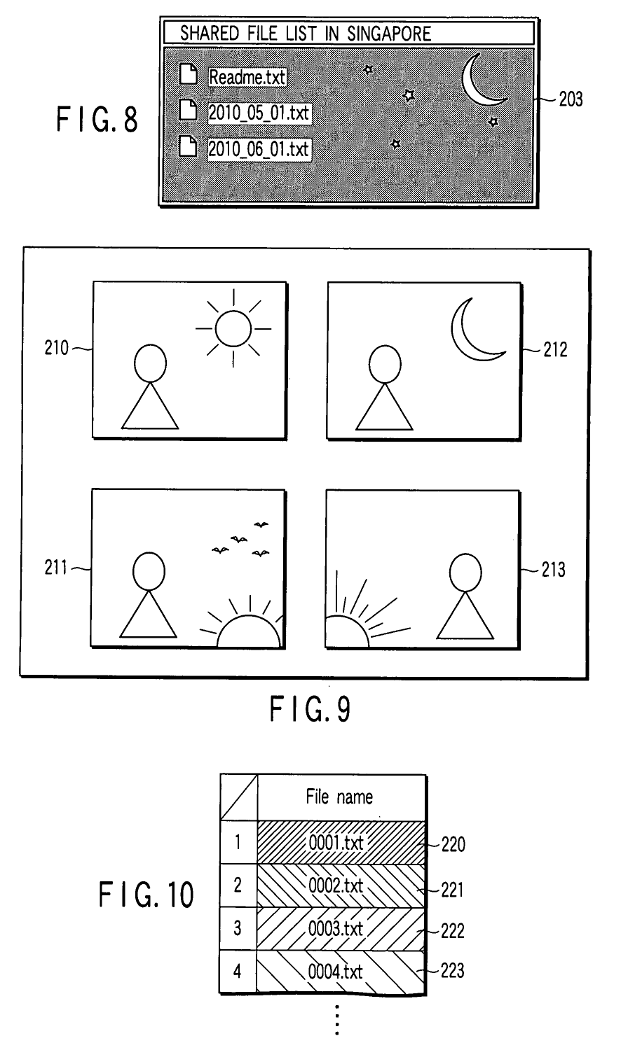

As the above background image, applied file “002.jpg” applied to a period from 9:01 to 15:00 in the “table of correspondence between background images and time” shown in FIG. 4, such as an image of daytime (FIG. 6) in which the sun rises high, applied file “003.jpg” applied to a period from 15:01 to 18:00 such as an image of evening (FIG. 7) in which the sun is setting, or applied file “004.jpg” applied to a period from 18:01 to 5:00 such as an image of night (FIG. 8) displaying the moon, can be used. If these screens are displayed in, for example, a single display screen, the time zone in the location where the shared files exist can be recognized intuitively. It can be recognized at a glance that, for example, the shared files provided at Los Angels are in the time zone in the morning, the shared files provided in Venezuela are in the time zone in the daytime, the shared files provided in Germany are in the time zone in the evening, and the shared files provided in Singapore are in the time zone in the night. The background images are not particularly limited to images of a celestial body corresponding to the above time, but may be any images corresponding to the time. For example, the background images may be images symbolizing daily life scenes such as getting up, doing job, going to bed, etc.

The time information transmitted from the transmitting-side host computer 10 is the information which is read from the current time maintaining unit 106 provided in the transmitting-side host computer 10. However, the transmitting-side host computer 10 may not comprise the current time maintaining unit 106, but may obtain the time information in the location where the transmitting-side host computer 10 is provided via the network 11. Moreover, the receiving-side host computer 12 stores the background images in the storage device 111, but may obtain the image data in a predetermined server, etc. via the network 11.

As described above, the local time of the computer storing the shared data can be recognized intuitively from the images displayed at the computer side which views the shared data.

Besides the predetermined shared files as described above, the shared data may be login information of the computer storing the shared data, use information (history information, user list, etc.) of a predetermined server such as a mail server, etc. For example, the login information of the computer storing the shared data may be information on each user logging in the computer storing the shared data as shown in FIG. 9. For example, when the local time in the location where the computer used by a user is provided is in the time zone of daytime, image of daytime 210 is displayed. When the local time in the location where the computer used by a user is provided is in the time zone of evening, image of evening 211 is displayed. When the local time in the location where the computer used by a user is provided is in the time zone of night, image of night 212 is displayed. When the local time in the location where the computer used by a user is provided is in the time zone of morning, image of morning 213 is displayed. Thus, as for the login information of the computer storing the shared data, too, the time zone of the local time of each user who logs in the computer can be recognized intuitively from the background images. In addition, if the images are similarly displayed on an address book of mailing software, the current time of the transmission destination can be recognized intuitively. The similar display can also be applied to a user list in a predetermined server such as a mail server.

FIG. 10 is an illustration of a data list in a case where the similar display is applied to the data list of the database. If the data lists connected via the network and located at several places of the world are displayed, the time zone of the local time can be recognized intuitively by displaying the local times of the computer storing the data items in different colors. For example, if the time zones of one day are separated into four time zones as shown in FIG. 4, it can be recognized at a glance that a computer storing file 0001.txt (220) has a background of the darkest color, which indicates the time zone of night, that a computer storing file 0002.txt (221) has a background of a slightly dark color, which indicates the time zone of evening, that a computer storing file 0003.txt (222) has a background of a slightly bright color, which indicates the time zone of morning, and that a computer storing file 0004.txt (223) has a background of the brightest color, which indicates the time zone of daytime.

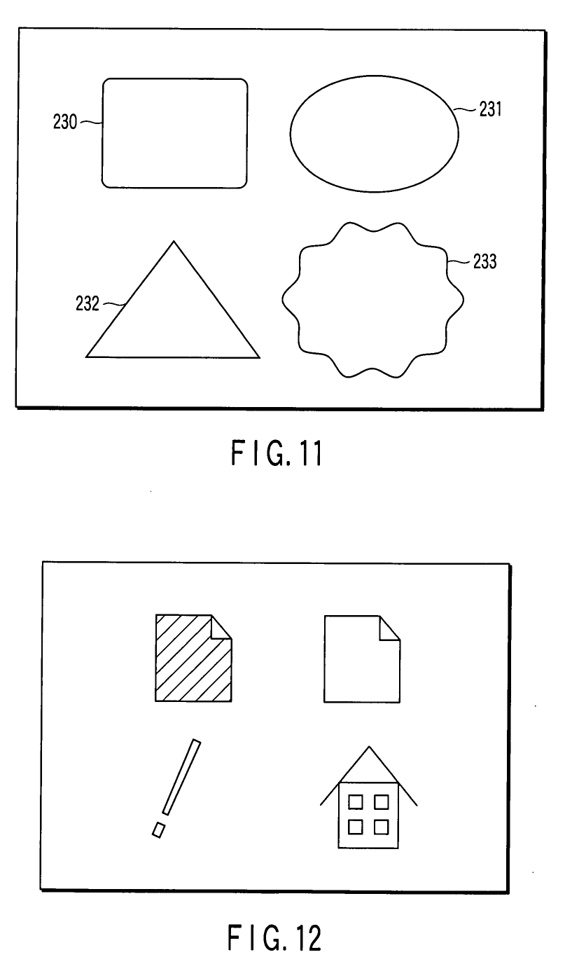

FIG. 11 is an illustration showing variation in a shape of the window frame displayed according to the time zone. For example, in the time zone of morning, a frame of “rectangle having round corners 230” is applied. In the time zone of daytime, a frame of “ellipsoid 231” is applied. In the time zone of evening, a frame of “triangle 232” is applied. In the time zone of night, a frame of “wave 233” is applied. Thus, the local time of the computer storing various kinds of information such as files, user information, etc. displayed in each frame can be recognized at a glance.

FIG. 12 is an illustration showing variation in a shape of the icon displayed according to the time zone. For example, in the time zone of morning, a “colored file-like icon” is applied. In the time zone of daytime, a “colorless file-like icon” is applied. In the time zone of evening, an “icon of exclamation mark” is applied. In the time zone of night, a “house-shaped icon” is applied.

Thus, the local time of the computer storing the file, etc. displayed by the icon can be recognized at a glance.

In the embodiment, the local time zone can be recognized intuitively by displaying the image information corresponding to the local time information. The time information may be displayed simultaneously with the image information, etc.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image display control system including a transmitting-side information processing device comprising shared data and a receiving-side information processing device viewing the shared data via a network,
the transmitting-side information processing device further comprising transmission means for, upon receiving an access from the receiving-side information processing device, transmitting list information of the shared data and local time information in a location where the transmitting-side information processing device is provided, to the receiving-side information processing device making the access,
the receiving-side information processing device comprising:
storage means for storing time-corresponding data;
reading means for receiving the list information of the shared data and the local time information in a location where the transmitting-side information processing device is provided, transmitted from the transmission means, and reading the time-corresponding data that correspond to the received local time information from the storage means; and
display means for associating the time-corresponding data which are read by the reading means with the received list information of the shared data, and displaying the shared data together with the time-corresponding data.

2. The system according to claim 1, wherein the transmitting-side information processing device and the receiving-side information processing device are connected, at local places having a time difference, via the network.

3. The system according to claim 1, wherein the time-corresponding data are at least one of image data corresponding to time, shape data corresponding to time, and color data corresponding to time.

4. The system according to claim 2, wherein the shared data are at least one of predetermined files, login information for each of the transmitting-side information processing device and the receiving-side information processing device, and use information of a predetermined server.

5. An image display control method of an image display control system including a transmitting-side information processing device comprising shared data and a receiving-side information processing device viewing the shared data via a network, the method comprising:
storing time-corresponding data in storage means of the receiving-side information processing device;
upon an access from the receiving-side information processing device to the transmitting-side information processing device, transmitting list information of the shared data and local time information in a location where the transmitting-side information processing device is provided, to the receiving-side information processing device making the access;
receiving the transmitted list information of the shared data and the transmitted local time information in the location where the transmitting-side information processing device is provided, and reading the time-corresponding data that correspond to the received local time information from the storage means; and
associating the time-corresponding data which are read by the reading means with the received list information of the shared data, and displaying the shared data together with the time-corresponding data on the receiving-side information processing device.

6. The method according to claim 5, wherein the transmitting-side information processing device and the receiving-side information processing device are connected, at local places having a time difference, via the network.

7. The method according to claim 5, wherein the time-corresponding data are at least one of image data corresponding to time, shape data corresponding to time, and color data corresponding to time.

8. The method according to claim 5, wherein the shared data are at least one of predetermined files, login information for each of the transmitting-side information processing device and the receiving-side information processing device, and use information of a predetermined server.

9. A program for urging a computer to execute:
storing time-corresponding data in storage means of a receiving-side information processing device;
upon an access from the receiving-side information processing device to a transmitting-side information processing device comprising shared data, transmitting list information of the shared data and local time information in a location where the transmitting-side information processing device is provided, to the receiving-side information processing device making the access;
receiving the transmitted list information of the shared data and the transmitted local time information in the location where the transmitting-side information processing device is provided, and reading the time-corresponding data that correspond to the received local time information from the storage means; and
associating the time-corresponding data which are read by the reading means with the received list information of the shared data, and displaying the shared data together with the time-corresponding data on the receiving-side information processing device.
